(19) United States
(12) Patent Application Publication
(10) Pub. No.: US 2024/0042703 A1
(43) Pub. Date: Feb. 8, 2024

(54) METHODS FOR MANUFACTURING PANEL ASSEMBLIES

(71) Applicant: Toyota Motor Engineering & Manufacturing North America, Inc., Plano, TX (US)

(72) Inventors: Nobuya Kawamura, Seaside, CA (US); Natsuhiko Katahira, Toyota City (JP); John Geriguis, Capitola, CA (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 17/817,497

(22) Filed: Aug. 4, 2022

(51) Int. Cl. B29C 65/16; B29C 65/00; B29C 45/00

(52) U.S. Cl. CPC B29C 65/16; B29C 66/7212; B29C 45/0005; B29K 2309/08

(57) ABSTRACT

A method for manufacturing panel assemblies is provided. The method includes, placing an outer surface of a panel on a mold. The panel includes a carbon fiber. The method further includes placing a channel on an inner surface of the panel. The channel includes a resin. The inner surface opposes the outer surface. The method further includes welding the channel onto the panel by heating the carbon fiber of the panel and placing a rib in the channel. The rib includes a carbon fiber. The method further include welding the rib onto the channel by heating the carbon fiber of the rib.

### TECHNICAL FIELD

The present specification generally relates to methods for manufacturing panel assemblies and, more specifically, methods for manufacturing panel assemblies.

### BACKGROUND

Panels (e.g., skin panels) constitute the outer surface of vehicles including ground vehicles (e.g., cars, boats, trains, or the like) and aerial vehicles (e.g., airplanes, glider, helicopter, drones, or the like). Generally, the panels require stiffening to prevent deformation.

### SUMMARY

In one embodiment, a method is provided. The method includes molding of an outer surface of a panel with an outermost limit (OML) tool. The panel includes a carbon fiber. The method further includes placing a channel on an inner surface of the panel. The channel includes a resin. The inner surface opposes the outer surface. The method further includes welding the channel onto the panel by heating the carbon fiber of the panel and placing a rib in the channel. The rib includes a carbon fiber. The method further include welding the rib onto the channel by heating the carbon fiber of the rib.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A depicts a cross sectional view of a panel being placed onto a mold, according to one or more embodiments shown and described herein;

FIG. 1B depicts a cross sectional view of channels being placed onto the panel, according to one or more embodiments shown and described herein;

FIG. 1C depicts a cross sectional view of the channels being welded onto the panel, according to one or more embodiments shown and described herein;

FIG. 1D depicts a cross sectional view of the ribs being welded onto the channels, according to one or more embodiments shown and described herein; and

FIG. 2 schematically depicts a method for manufacturing panel assemblies, according to one or more embodiments shown and described herein.

### DETAILED DESCRIPTION

Panels constitute an outer surface of vehicles and reinforcing ribs are placed on the panels to add stiffness and prevent deformation. Methods provided herein relate to fabricating the panel assemblies with channels and ribs. Various embodiments of methods for manufacturing the panel assemblies will be described in more detail herein.

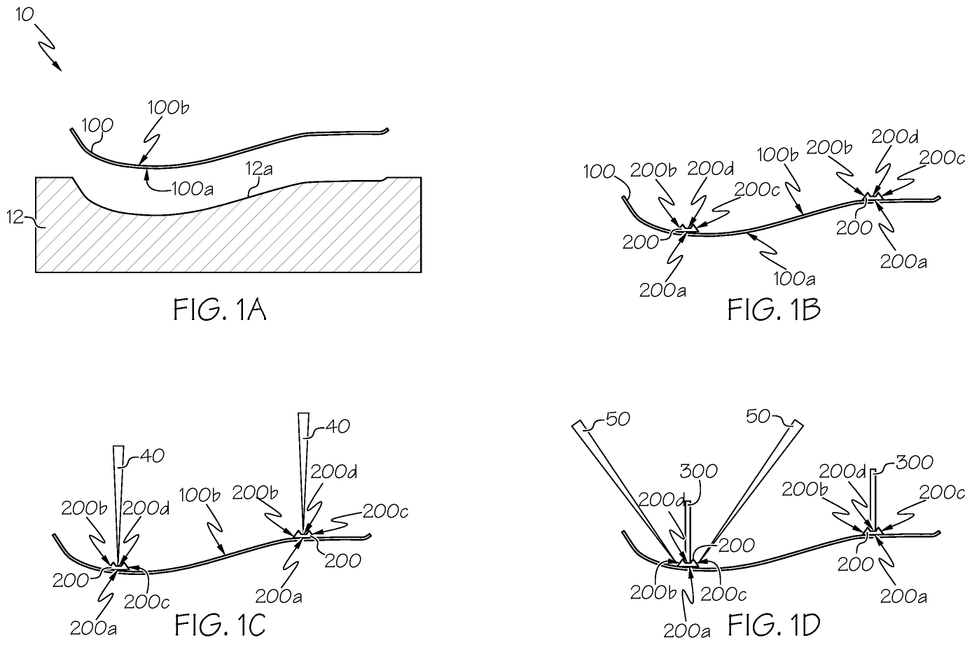

Referring to FIG. 1A, a panel assembly 10 including a panel 100 (e.g., a skin panel) is illustrated. The panel 100 is placed on a mold 12. The panel 100 may be made of material including carbon fiber, which can be heated by laser irradiation. For example, the panel 100 may be made of carbon fiber-reinforced polymers (CFRP). The panel has an outer surface 100a (e.g., an outermost limit surface) and an inner surface 100b (e.g., an innermost limit surface) opposite to the outer surface 100a.

When used as a skin panel of a vehicle, the outer surface 100a becomes an outer surface of the vehicle. The outer surface 100a may have aerodynamic surface, which may enhancing aerodynamic properties to improve aerodynamic performance and withstand erosive conditions. The aerodynamic surface may be smooth and continuous. In embodiments, the outer surface 100a may be laminated. A laminating process (e.g., an automated fiber placement (AFP) process, automated tape laying (ATL) process, or the like) may be used to laminate the panel 100. The laminating process may include placing a carbon fiber tape on the mold 12 to form a carbon fiber tape layer, placing the panel 100 on the top of the carbon fiber tape layer, applying heat and/or pressure to consolidate the panel 100 with the carbon fiber tape layer.

The mold 12 supports the outer surface 100a of the panel 100. The panel 100 may be laminated before being placed on the mold 12 or be laminated on the mold 12. The mold 12 may be an outermost limit (OML) tool supporting the outermost limit of the outer surface 100a of the panel 100. The OML tool may also be defined as an outer mold line tool. The mold 12 includes an OML tool surface 12a. In embodiments, the panel 100 is not placed on the mold 12 (i.e., the panel 100 is taken off from the mold 12) during the manufacturing process.

In embodiments, the mold 12 may hold the panel 100 in place during the manufacturing process. In such case, the outermost limit of the outer surface 100a of the panel 100 is placed on the OML tool surface 12a of the mold 12.

The mold 12 conforms the shape of the panel 100, and specifically conforms the shape of the outer surface 100a of the panel 100. Therefore, the mold 12 may be designed without concerning other parts to be assembled (e.g., a channel 200 and/or a rib 300 (shown in FIGS. 1B-1D)) onto the inner surface 100b of the panel 100. Once the design of the outer surface 100a of the panel 100 is finalized, the mold 12 may be fabricated without further consideration of the parts to be assembled on to the inner surface 100b of the panel 100. The mold 12 may include ribs or other stiffening members along the mold 12 to provide sufficient stiffness to react pressure applied to the panel 100 during the manufacturing process of the panel assembly 10.

Referring to FIG. 1B, one or more channels 200 are placed on the inner surface 100b of the panel 100. The channels 200 may be made of a resin by an injection molding process. The channels 200 may be made of a glass fiber filled resin (e.g., glass fiber reinforced polymer (GFRP) or the like). The resin used for the channels 200 melts by heat. The resin may be melt at a certain melting temperature. Laser irradiation of a carbon fiber may reach at or above the melting temperature.

Each channel 200 has a bottom portion 200a and one or more wall portions 200b, 200c. The channels 200 may be a C channel, a U channel, or the like, which may be grooved between the wall portions 200b, 200c to form a groove portion 200d. In embodiments, the channels 200 may have one wall portion. The channels 200 may be fabricated into strips by extrusion molding. The bottom portion 200a is disposed between the wall portions 200b, 200c, and the wall portions 200b, 200c extend away from the bottom portion 200a. Therefore, when the channels 200 are placed on the panel 100, the wall portions 200b, 200c extend away from the inner surface 100b of the panel 100.

Referring to FIG. 1C, a laser beam 40 is directed onto the channel 200 to weld the channel 200 onto the panel 100. The laser beam 40 may heat the carbon fiber of the panel 100, and the heat may melt the resin of the channel 200. For example, the laser beam 40 is directed toward the bottom portion 200a of the channel 200. The laser beam 40 may be localized to the panel 100 and heat the carbon fiber of the panel 100. For example, the laser beam 40 is localized to the inner surface 100b of the panel 100 where the channel 200 is disposed thereon.

The heat generated from the carbon fiber of the panel 100 melts the resin of the bottom portion 200a of the channel 200. Therefore, the channel 200 and the panel 100 become conduction welded together. In other words, the melted resin acts as an adhesive or a bond for attaching the channel 200 to the panel 100.

Referring to FIG. 1D, each rib 300 is placed on the respective channel 200. The rib 300 may be a stiffener, a spar web, or the like, which may support the structural strength of the panel 100. In embodiments, the rib 300 may be made of material including carbon fiber, which can be heated by laser irradiation. For example, the rib 300 may be made of carbon fiber-reinforced polymers (CFRP). The rib 300 may be laminated by the AFP or ATL process. The AFP or ATL process may include placing a carbon fiber tape on a mold to form a carbon fiber tape layer, placing the rib 300 on the carbon fiber tape layer, and applying heat and/or pressure to consolidate the rib 300 with the carbon fiber tape layer. The rib 300 may be then cut into desired profiles.

In embodiments, the rib 300 is inserted into the groove portion 200d. For example, the rib 300 may be butt joint inserted into the groove portion 200d without special shaping of the inserted end of the rib 300. The groove portion 200d may hold the rib 300 inserted in the groove portion 200d at one end of the rib 300. In embodiments with the channel 200 with one wall portion, the rib 300 may be placed to be in contact with the wall portion and a surface of the bottom portion facing away from the panel 100. The inserted end of the rib 300 may be heated by a laser beam 50. The laser beam 50 may be directed toward one or both of the wall portions 200b, 200c of the channel 200 or the groove portion 200d of the channel. The laser beam 50 may be focused to the inserted end of the rib 300 and heat the carbon fiber of the rib 300. The heat generated from the carbon fiber of the rib 300 melts the resin of the wall portions 200b, 200c of the channel 200 or the resin of the groove portion 200d of the channel 200. Therefore, the rib 300 and the channel 200 become conduction welded together. In other words, the melted resin acts as an adhesive or a bond for attaching the rib 300 to the channel 200.

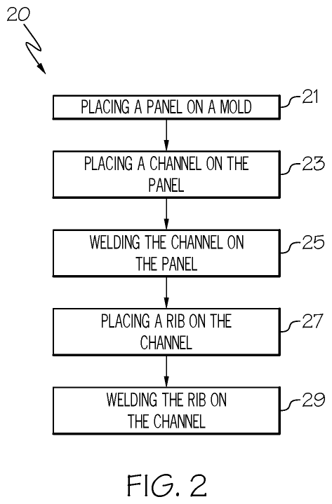

Referring to FIG. 2, a method 20 for manufacturing the panel assembly 10 is provided. At step 21, the panel 100 is placed on the mold 12. In embodiments, the panel 100 may be laminated by a laminating process (e.g., the AFP process, the ATL process, or the like) and a laminated layer (e.g., the carbon fiber tape layer) may constitute the outer surface 100a of the panel 100. The laminate panel 100 may be further consolidated by press or autoclave. In embodiments, quality inspection may be performed after the lamination and consolidation processes to ensure quality of the laminated panel 100. The panel 100 may remain on the mold 12 after the lamination and consolidation processes, or the panel 100 can be placed onto a separate jig fixture.

At step 23, the channel 200 is placed on the panel 100. The channel 200 may be placed at a certain position for adding structural strength to the panel 100 based on a design and a purpose of the panel 100. The channel 200 may be placed directly onto the panel 100 without any intervening layers or material. For example, the bottom portion 200a of the channel 200 is in direct contact with the inner surface 100b of the panel 100.

At step 25, the channel 200 is welded on the panel 100. The resin of the channel melts when a laser beam 40 is directed toward the contact portion between the bottom portion 200a and the inner surface 100b. The laser heats the carbon fiber of the panel 100 and the heat melts the bottom portion 200a of the channel 200. In embodiments, the laser beam 40 is localized to generate heat from the carbon fiber, and the power of the laser beam 40 may be set to heat the carbon fiber to a temperature not deforming the channel 200 but melting the bottom portion 200a to laser weld the channel 200 to the panel 100. In case there are a plurality channels 200, the laser welding process may be simultaneously performed depending on the number of laser beam sources available for the laser welding process.

In embodiments, steps 23 and 25 may be in one step when 3D printing technology is utilized to deposit the channel 200 on the inner surface 100b.

At step 27, the rib 300 is placed on the channel 200. The rib 300 may be laminated by a laminating process (e.g., the AFP process, the ATL process, or the like) similar to the laminating process of the panel 100. A laminated layer (e.g., the carbon fiber tape layer) may constitute the outer surface of the rib 300. The laminated panel 100 may be further consolidated by press or autoclave. In embodiments, quality inspection may be performed after the lamination and consolidation processes to ensure quality of the rib 300. After being laminated and consolidated, the rib 300 may be cut into desired profiles to be fit into the channel 200 and to add structural strength to the panel 100 when assembled. In embodiments, the rib 300 may be quality inspected before being placed onto the channel 200. In embodiments, the rib 300 may be placed onto the groove portion 200d of the channel 200 at step 27. When being placed, the rib 300 may free stand on the channel 200 or the rib 3 or held by a tool.

At step 29, the rib 300 is laser welded to the channel 200 by being heated to melt the wall portions 200b, 200c of the channel 200. The laser beam 50 may be directed toward the inserted portion of the rib 300 and heat the carbon fiber of the rib 300. The heat from the carbon fiber may melt the wall portions 200b, 200c. The laser beam 50 may be directed toward the wall portion 200b, and then directed toward the wall portion 200c to ensure the both wall portions 200b, 200c are laser welded to the rib 300. In embodiments, the laser beam 50 may include a plurality of laser beams that are directed toward both of the wall portions 200b, 200c at the same time. In embodiments, the laser beam 50 is localized to generate heat from the carbon fiber, and the power of the laser beam 50 may be set to heat the carbon fiber to a temperature not deforming the channel 200 but melting the wall portions 200b, 200c to laser weld the rib 300 to the channel 200. In case there are a plurality channels 200 and respective ribs 300, the laser welding process may be simultaneously performed depending on the number of laser beam sources available for the laser welding process. The panel assembly 10 may be separated from the mold 12 after the step 29.

In embodiments, after steps 21, 23, and 27, steps 25 and 29 may be conducted at the same time.

As discussed above, the panel 100, the channel 200, and the rib 300 may be fabricated prior to the manufacturing process of the panel assembly 10. This may enable the parts (e.g., the panel 100, the channel 200, and the rib 300) to be individually inspected before being assembled together. Defective parts may not be used in manufacturing process of the panel assembly 10, which may save process time and reduce a number of possible manufacturing of defective panel assemblies. Further, individual fabrication of the parts may provide extra quality inspections to improve quality of the panel assembly 10. For example, quality inspection steps may be performed at the end of every steps including steps 21, 23, 25, 27, and 29 of manufacturing the panel assembly 10.

It should now be understood that the embodiments disclosed herein include methods for manufacturing the panel assemblies including the panel, the channel, and the rib. Embodiments may provide manufacturing methods utilizing the OML tool to define aerodynamic outer surface of the panel assembly, while stiffening the panel with the channel and the rib disposed on the inner surface of the panel.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

1. A method comprising:
placing an outer surface of a panel on a mold, the panel including a carbon fiber, wherein the mold comprise an outermost limit (OML) tool configured to conform a shape of the outer surface and support an outermost limit of the outer surface of the panel;
placing a channel on an inner surface of the panel, the channel including a resin, the inner surface opposing the outer surface;
welding the channel onto the panel by heating the carbon fiber of the panel;
placing a rib in the channel, the rib including a carbon fiber; and
welding the rib onto the channel by heating the carbon fiber of the rib, wherein the channel comprises wall portions and a bottom portion disposed between the wall portions, a top surface of the bottom portion operably receives the rib, and a bottom surface of the bottom portion operably contacts with the inner surface of the panel.

2. The method of claim 1, wherein the carbon fiber of the panel is heated by laser irradiation.

3. The method of claim 1, wherein the carbon fiber of the rib is heated by laser irradiation.

4. The method of claim 1, wherein the channel further includes a glass fiber.

5. The method of claim 1, wherein welding the channel onto the panel further includes melting the resin of the channel by heating the panel to a melting temperature of the resin.

6. The method of claim 1, wherein welding the rib onto the channel further includes melting the resin of the channel by heating the rib to a melting temperature of the resin.

7. The method of claim 1, wherein the wall portions extend from the bottom portion.

8. The method of claim 7, wherein welding the channel onto the panel includes melting the bottom portion of the channel.

9. The method of claim 7, wherein welding the rib onto the channel includes melting the wall portions of the channel.

10. The method of claim 1, further comprising injection molding the channel.

11. (canceled)

12. The method of claim 1, wherein the channel includes glass fiber reinforced plastic material.

13. The method of claim 1, wherein placing the rib in the channel comprises inserting the rib into a groove portion formed by the wall portions and the bottom portion.

14. The method of claim 1, wherein:
a groove portion is disposed between the wall portions; and
the wall portions extend away from the bottom portion of the channel.

15. The method of claim 1, wherein the mold further comprise a stiff member configured to provide stiffness to react pressure applied to the panel.
